(19) United States
(12) Patent Application Publication
(10) Pub. No.: US 2011/0106597 A1
(43) Pub. Date: May 5, 2011

(54) Methods And Systems For Offering Discounts

(75) Inventors: Mark Alan Ferdman, Scarsdale, NY (US); Craig Elimeliah, New York, NY (US); Robert David Forras, Broussard, LA (US)

(73) Assignee: PUSHKART, LLC, Brooklyn, NY (US)

(21) Appl. No.: 12/913,359

(22) Filed: Oct. 27, 2010

Related U.S. Application Data
(60) Provisional application No. 61/226,784, filed on Oct. 28, 2009.

(51) Int. Cl. G06Q 30/00

(52) U.S. Cl. 705/14.11; 705/14.4; 235/375

(57) ABSTRACT

A method for providing incentives includes receiving identification data from a customer; receiving incentive data from a merchant, the incentive data; accessing at least one social network account of the customer to access social network data, the social network data including text of social network communications and a size of the at least one social network account; determining demographic qualities of the at least one social network account determining an incentive based on the size and demographic qualities of the at least one social network account and the incentive data; receiving input from the customer as to whether to accept the incentive determined; and broadcasting a promotional message through the at least one social network account if the costumer accepts the incentive.

### CROSS-REFERENCE TO RELATED APPLICATIONS

The present disclosure claims the benefit of the filing date of U.S. Provisional Patent Application No. 61/226,784 filed Oct. 28, 2009, the entire disclosure of which is hereby incorporated herein by reference.

### BACKGROUND OF THE INVENTION

The present disclosure relates to methods and systems for providing incentives to a customer associated with a social network and, more specifically, to methods and systems for offering incentives to customers based on the numbers and demographic qualities of contacts contained in their social network accounts.

Social network sites have proliferated through the Internet. These sites allow a user to connect with “friends” or contacts. The users associated with these social network sites can also broadcast messages from their social networks instantaneously. For the most part, these messages include personal communications. The proliferation of social network sites, however, presents a unique opportunity for merchants. For instance, merchants may market their products or services using social network sites. It is therefore desirable to use the social network to market product and/or services.

### BRIEF SUMMARY OF THE INVENTION

Merchants can also create social network accounts, allowing them to connect with potential customers. Such connections allow the merchant to transmit promotional messages through the social network platform. These promotional messages are often broadcast from the merchants' social network accounts. The inventors have realized that merchants could employ their consumers' social network platforms to broadcast promotional messages to a wider audience.

The present disclosure relates to methods for providing incentives to customers associated with one or more social network sites. In some embodiments, the method comprises receiving identification data from a customer; accessing at least one social network account of the customer to access social network data associated with the customer, the social network data including the number of social network contacts of the customer and their related social network data; running the data through an algorithm to create a “demographic quality score”; determining an incentive based on the size and demographic qualities of social network contacts of the customer with a processor; receiving input from the customer as to whether to accept the incentive determined by the processor; and broadcasting a promotional message from the social network account(s) of the customer. As used herein, the term “promotional message” may include a deal, an incentive for the customer, or any other marketing communication. The promotional message may be broadcast when the customer completes a purchase if the costumer accepts the incentive. Alternatively, the promotional message may be broadcast even if the consumer does not complete a purchase.

The present disclosure further relates to systems for providing incentives to customers associated with one or more social network sites. In certain embodiments, the system comprises a social network database for storing social network data associated with users of a social network site, a social network server coupled to the social network database, an application server capable of establishing communication with the social network server via a network and receiving social network data stored on the social network database, and an application database coupled to the application server for storing social network data about the customer. The application server is configured to receive identification data from a customer, communicate with the social network server to retrieve social network data including the number of social network contacts of the customer and their related social network data; running the data through an algorithm to create a “demographic quality score”; determining an incentive based on the s, receiving input from the customer as to whether to accept the incentive determined by the processor, and broadcasting a promotional message from the social network account(s) of the customer. As discussed above, the term “promotional message” may include a deal, an incentive for the customer, or any other marketing communication. The promotional message may also include a notification that the customer made the purchase. During operation, the promotional message may be broadcast when the customer completes a purchase if the costumer accepts the incentive. Alternatively, the promotional message may be broadcast before the customer completes the purchase.

The present disclosure also relates to a computer readable medium including instructions that, when executed by a processor, causes the process to perform the following steps: receiving identification data from a customer; accessing at least one social network account of the customer to retrieve social network data including the number of social network contacts of the customer and their related social network data; running the data through an algorithm to create a “demographic quality score”; determining an incentive based on the size and demographic qualities of the customer's contacts; receiving input from the customer as to whether to accept the incentive determined by the processor; and broadcasting a promotional message from the social network account(s) of the customer when the customer completes a purchase if the costumer accepts the incentive.

### BRIEF DESCRIPTION OF TEE DRAWINGS

FIG. 1 is a block diagram of a system for providing incentives to customers associated with a social network site;

FIG. 2 is a flowchart illustrating part of a method for providing incentives to customers associated with a social network site;

FIG. 3 is a flowchart illustrating another part of a method depicted in FIG. 2;

FIG. 4 is a flowchart illustrating part of a method for determining the demographic qualities of one or more social network accounts;

FIG. 5 is a flowchart illustrating another part of the method of FIG. 4;

FIG. 6 is a block diagram of a system for providing incentive to customers associated with a social network sites according to another embodiment of the present disclosure;

FIG. 7 is a flowchart illustrating another method for providing incentives to customers associated with a social network site;

FIG. 8 is a flowchart illustrating part of yet another method for providing incentives to customers associated with a social network site; and

FIG. 9 is a flowchart illustrating another part of the method of FIG. 8.

### DETAILED DESCRIPTION

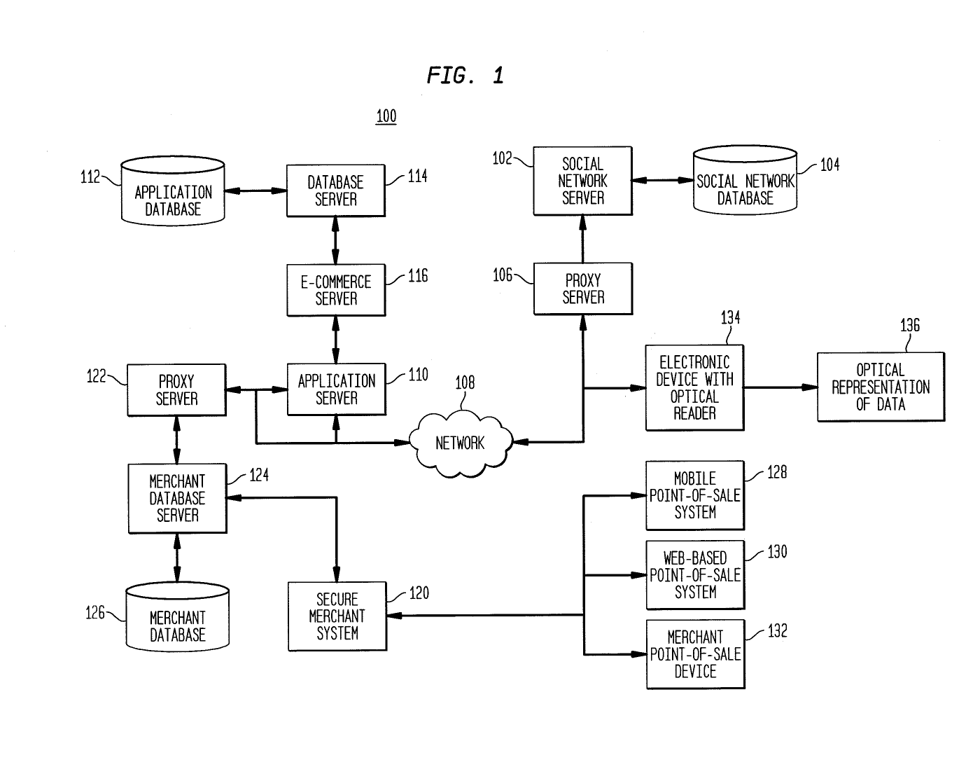

FIG. 1 depicts a block diagram of a system 100 for providing an incentive, such as a discount, rebate, or credit, to purchasing customers having one or more accounts in at least one social network site. In the following description and in the appended claims, the term “social network” includes, but is not limited to, social networking platforms, such as Facebook, MySpace, Linked-in Friendster, Bebo, Orkut, Hi5, j Tagged, Ning, and Twitter. As used herein, the term “social network” also includes social aggregators that consolidate information and updates from social websites, such as social networks, social bookmarking sites, and blog, such as FriendFeed and SocialThing!; online virtual words such as Second Life; social networks for sharing videos, photos, presentations, etc., such as YouTube, Flickr, SlideShare and Photobucket; services that allow websites external to social networks to access social network user data, such as FriendConnect, Facebook Connect and MySpace Data Availability; and other Web 2.0 platforms that allow users to make connections and to share and communicate comments, links, music, video, data, or any other kind of information.

In some embodiments, system 100 includes one or more social network servers 102 and one or more social network databases 104 for storing social network data. As used herein, the term “database” may include any non-transitory computer-readable medium capable of storing data. The social network server 102 is coupled to social network database 104 and processes, compiles, and manipulates the social network data stored on the social network database 104. In some embodiments, social network server 102 is capable of storing and retrieving data from social network database 104. Each social network server 102 may be connected to a proxy server 106 for filtering communication with social network server 102. Each proxy server 106 may include one or more firewalls for blocking unauthorized access while permitting authorized communications.

The social network database 104 may store, among other things, social network data and/or user profile data, including personal information such as, but not limited to, the first name and last name of the user, a valid email address, a unique user identifier within the social network, birth date, gender, occupation, etc. The user profile data may further include interest information, which may include, but is not limited to, activities, hobbies, photos, etc. Social network database 104 may also store a user's social network contacts, which may include, but is not limited to, list of friends within the social network, list of family within the social network, list of acquaintances within the social network, total number of contacts within the social network, etc.

Social network server 102 may include one or more software agents and/or hardware modules for establishing a social network-based platform for users. In one embodiment, social network server 102 can execute a social network software application that allows a social network user to invite a member of the social network to become a friend. Upon receiving such invitation, the invited member may accept the invitation and become the user's friend or contact. Then, the invited member will be listed as a fried or contact in the user's list of social network contacts. Social network database 104 may be managed by any suitable database management system, such as Oracle, DB2, Microsoft Access, Microsoft SQL Server, Postgre SQL, MySQL, FileMaker, etc.

The social network software application of social network server 102 may also facilitate interaction and communication among the members of the social network. For example, members of the social network may upload photo, videos, and notes to share with other members of the social network. In addition, the social network server 102 may facilitate sharing of information about news and activities of members of the social network with other members designated as friend or contacts within the social network. Social network server 102 can also provide social network data and/or user profile data from social network database 104 to another authenticated server, such as application server 110, via network 108.

Social network server 102 is connected to a network 108 directly or through one or more proxy servers 106. Network 108 may be a telephonic network, an open network, such as the Internet, a private network, such as an intranet and/or extranet, a local area network (LAN) or a wide area network (WAN) or a combination thereof. Network 108 may constitute one or more wired or wireless networks and/or collection of distinct networks operating wholly or partially in conjunction to provide connectivity to social network server 102. Network 108 may employ any suitable protocol, such as secure sockets layer (SSL), transport layer security (TLS), or Secure HyperText Transfer Protocol (S-EPPT), to achieve a secure communication. As briefly discussed above, network 108 facilitates communication between social network server 102 and application server 110.

Application server 110 may include software agents and/or hardware modules, such as an embedded web-based application or a host solution application, for generating a customized incentive, such as a discount, rebate, or reward, with a widget, webpage, and/or incentive application integrated with one or more merchant transactional systems. As used herein, a “merchant” refers to a retailer, a wholesaler, or any other person or entity selling tangible and/or intangible goods and/or services. In use, application server 110 can communicate with social network server 102 via network 108 to receive information about a purchasing customer from the purchasing customer's social network profile data. The information from the purchasing customer's social network profile data may be stored on an application database 112 for later retrieval and analysis.

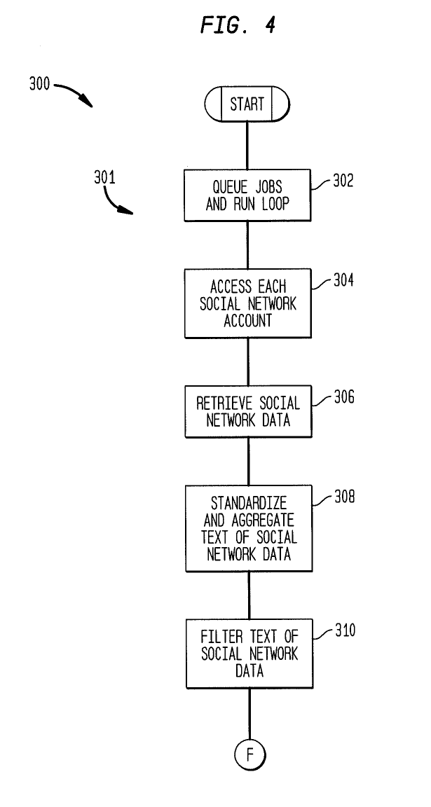

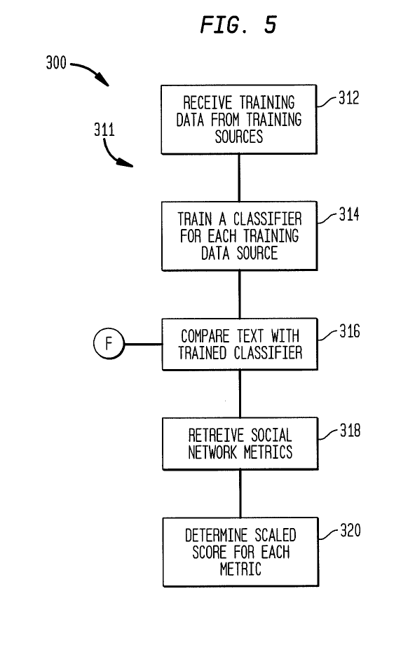

Application server 110 includes an incentive application or hardware module that generates an incentive for a purchasing customer based, in part, on the information received from the purchasing customer's social network profile data. The incentive application and/or hardware module manages the log-on process into the social network application run by the social network server 102. The incentive is mostly or solely based on the size and/or demographic qualities of social network(s) of the purchasing customer, and the geographic location of the purchasing customer. The size of the purchasing customer's social network(s) may be measured by the number of social network contacts. The demographic qualities of the purchasing customer's social network(s) may be determined by a social networth algorithm, as discussed in detail below with respect to FIGS. 4 and 5. The geographic location of the customer may be determined, for example, by a global positioning (GPS) system associated with the electronic device 134, as discussed in detail below. In order to obtain a customer's geographic location, the electronic device 134 may send and then receive a signal indicative of the electronic device's geographic location from a GPS system. Based on the information provided by the GPS system, the electronic device 164 sends geographic location data to application server 110. The geographic location data may include any suitable location information about the customer, such as the geographic coordinates of the customer's electronic device 134. The customer may access incentives from merchants with business close to the customer's geographic location. In certain embodiments, the incentive application may be an embeddable plug-in code, such as a HyperText Markup Language (HTML) code, Extensible Markup Language (XML) code and/or JavaScript code, plugged directly into a secure merchant commerce and transactional software system 120. The embeddable plug-in code includes an application-programming interface (API) for facilitating interaction between merchant transactional system 120 and application server 110. Suitable APIs include Simple Object Access Protocol (SOAP) web service, Representational State Transfer (REST or RESTful) web service, Java API for XML-based RPC (JAX-RPC) and/or XML-RPC.

Application server 110 includes one or more firewalls for blocking unauthorized access while permitting authorized communications. In some embodiments, the firewall includes one or more hardware modules and/or software components capable of enforcing a predetermined set of access rights. The firewall may additionally manage and/or have access to an access control list detailing permissions. These permissions may include access and operation rights of an object by an individual, a machine, and/or an application, and the circumstances under which the permission rights stand. Each user or potential purchasing customer may have an account and an associated identifier for accessing the user account stored on application database 112. For example, the incentive application and/or hardware module may employ a username/email and password identification method for authorizing access. Other methods of identity authentication, such as security cards and/or digital certificates, may be utilized. A user or potential purchasing customer may be able to specify and/or obtain a logon ID after subscribing or registering. During the logon process, the incentive application or hardware module gathers data (such as username/email and password) to determine if a user is authorized to access the system, and if so, securely logs the user to his or her account.

Application database 112 is coupled to application server 110 via any suitable connection. The information stored on application database 112 may be managed by a database server 114. Database server 114 can run any suitable database management system, such as Oracle, DB2, Microsoft Access, Microsoft SQL Server, Postgre SQL, MySQL, FileMaker, etc. Application server 110 can store and retrieve data from application database 112.

Application database 112 stores incentive data necessary to determine the incentive to be offered to a purchasing customer, including, but not limited to, rules and/or instructions for determining and/or calculating the incentive. Application server 110 can store and retrieve the incentive data from application database 112 and execute an incentive software application and/or hardware module able to determine the incentive. The incentive application determines the incentive (e.g., discount) offered to a purchasing customer based, for example, on the size and/or demographic qualities of is or her social network account(s) and the incentive rules or instructions provided by a merchant.

The incentive application run by the application server 110 additionally generates a merchant interface or an entry data form. Each merchant may have an account and an associated identifier for accessing the entry data form and/or merchant interface. For example, the incentive application may employ a username/email and password identification method for authorizing access. In other embodiments, other methods identity authentication, such as security cards and/or digital certificates, may be utilized. A merchant may be able to specify and/or obtain a logon ID after subscribing or registering. During the logon process, the incentive application and/or hardware module gathers data (such as username/email and password) from application database 112 to determine if a merchant is authorized to access the account, and, if so, securely logs the merchant into the account granting the merchant access to the entry data form or merchant interface.

The entry data form or merchant interface allows a merchant to input merchant data. The merchant data may include, but is not limited to, information concerning the rules and/or instructions for determining an incentive based on the size and/or demographic qualities of social network account(s) of the purchasing customer, and the geographic location of the customer. Moreover, the merchant data may include a list of goods and/or services (or combination thereof) eligible for the incentive. In addition, the merchant data may include information about the merchant's promotional message, deal or notification and geographic location of the merchant's physical site. As discussed above, the incentive application run by application server 110 may include an API, such as SOAP webservice or RESTful webservice, for facilitating broadcast of the promotional message or notification to the purchasing customer's social network contacts. The promotional message may include clickable objects, such as clickable banners, clickable text and clickable links. In some embodiments, the promotional message or notification includes information identifying the purchasing customer and a clickable link leading to a website containing additional information about the purchase made by the purchasing customer or about the merchant. The promotional message may also include data or information about a deal and a link to retrieve said deal. After a merchant has entered the desired merchant data in the entry data form, the merchant data is stored on application database 112. Application server 110 can store and retrieve merchant data from application database 112. Merchant data may be manually entered by a merchant or automatically retrieved from another database, such as merchant database 126.

Application database 112 is coupled to an E-commerce server 116 via any suitable connection. E-commerce server 116 includes software agents and/or hardware modules capable of charging a fee to the merchant for using the incentive application. As discussed above, each merchant may have an account and an identifier associated with the account. In one embodiment, the merchant accesses its account and electronically pays a predetermined fee upon receipt of a bill. Alternatively, the merchant may fund the account with money or credit. Data containing information about the merchant's funds is stored on application database 112. E-commerce server 116 can store and retrieve the merchant's data concerning the merchant's balance and execute the e-commerce software application and/or hardware module to debit the appropriate fee from the merchant's account. The funds may be debited from the merchant's account upon use of the incentive application or at predetermined times. For example, the merchant's account may be debited every night at a specific time.

Application server 110 can also interact and communicate with a merchant database server 124 via network 108 or any other suitable connection. Merchant database server 124 may be connected to a proxy server 122, which protects merchant database server 124 from unauthorized access. Proxy server 124 filters communication between merchant database server 124 and application server 110 or any other server or system. Each proxy server 124 may include one or more firewalls for blocking unauthorized access while permitting authorized communications. In some embodiments, the firewall includes one or more hardware modules and/or software components capable of enforcing a predetermined set of access rights. The firewall may additionally manage and/or have access to an access control list detailing permissions. These permissions may include access and operation rights of an object by an individual, a machine, and/or an application, and the circumstances under which the permission rights stand.

As discussed above, proxy server 122 controls communications with merchant database server 124. Merchant database server 124 is coupled to a merchant database 126 and includes software agents and/or hardware modules for managing, compiling, and processing the data stored on merchant database 126. In some embodiments, merchant database server 126 executes a data management system, such as Oracle, DB2, Microsoft Access, Microsoft SQL Server, Postgre SQL, MySQL, FileMaker, etc., to manage the data stored on merchant database 126.

Merchant database 126 stores and provides a secure merchant system 120 with sales data including, but not limited to, catalogs listing goods and/or services for sale, prices, reviews, instructions for completing transactions, etc. Merchant database server 124 includes software agents and/or hardware modules, such as secure merchant system 120, for executing and completing sale transactions originating from one or more point-of-sales (POS). Secure merchant system 120 can generate a virtual shopping cart for storing a list of the goods and/or services to be purchased by a purchasing customer. In addition, secure merchant system 120 can also generate a checkout page associated with the shopping cart. The checkout page can process the content of the shopping cart and finalize a transaction. An API plug-in of the incentive application is embedded on the checkout page or any other software component of secure merchant system 120. As discussed above, the API plug-in may be a JavaScript code.

One or more POS systems are coupled to secure merchant system 120 via network 108 (or any other suitable connection) and include an output device, such as a screen or monitor, for displaying a user interface generated by the API plug-in. In some embodiments, secure merchant system 120 is coupled to a mobile POS system 128, a web-based POS (WPOS) system 130 and/or merchant POS device or terminal 132 via network 108 or any other suitable connection. Merchant POS device 132 may include an electronic cash register located at a physical retail and/or wholesale establishment.

The user interface generated by API plug-in allows a user or purchasing customer to interact with the incentive application. Like most POS systems, the purchasing customer may initiate a checkout process after selecting the desired goods and/or services at a checkout page. During the checkout process, API plug-in displays an initial message on the shopping cart and/or checkout page, asking the purchasing customer whether he or she wants to receive an incentive in exchange for permission to broadcast a promotional message from his or her social networks. This initial message may additionally contain specific information about the incentive like, for example, a discount percentage. In one embodiment, the initial message includes the following sentence: “By broadcasting your purchase you can save up to 10% on your order right now!”

The purchasing customer may respond to this inquiry in the affirmative. Upon an affirmative response, the API plug-in displays a second message, asking the purchasing customer for permission to access and update its social network profile. At this point, the API plug-in employs a username/email and password identification method or any other suitable authentication method for authorizing access. The shopping cart calls a webservice, such as a SOAP-based webservice, running on application server 110 to finalize the transaction and broadcast the promotional message or notification from the purchasing customer's social networks. As discussed in detail below, the purchasing customer may accept the incentive by, among other things, scanning any optical representation of data 136 with an electronic device 134.

As discussed above, the promotional message or notification broadcasted from the purchasing customer's social networks may include a link to additional information about the purchase or merchant. The purchasing customer's social network contacts may click the link to access the merchant's webpage. The incentive application running on application server 110 tracks the amount of times a social network contact clicked the link (i.e., click-thru data) and stores said click-thru data on the application database 112. A merchant may access its account to access the click-thru data.

The E-commerce server 116 may execute an e-commerce application that utilizes the click-thru data to charge the merchant per each click-thru. The E-commerce application may (additionally or alternatively) charge a fee to the merchant based on the number of times the promotional messages was delivered (i.e., per impressions) or per broadcasted promotional message.

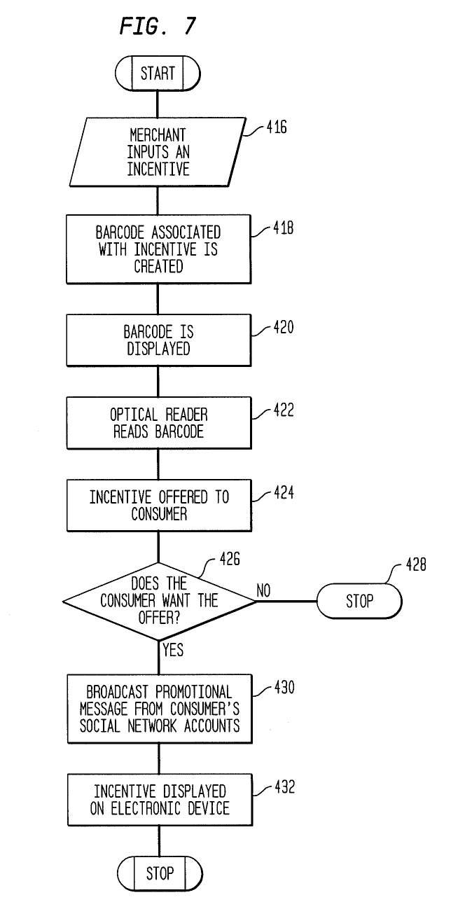

Application server 110 can also interact and communication with an electronic device 134 via network 108. As discussed above, network 108 may be the Internet. Ordinarily, the electronic device 134 may not be connected to a POS system and may be a Smartphone with an optical reader or any other suitable hardware module and/or software capable of reading an optical representation of data 136, such as a QR code or a barcode. The optical reader of electronic device 134 may include a camera and software adapted to reach the optical representation of data 136, such as a QR code. In certain embodiments, a Quick Response code or QR code refers to a two-dimensional matrix barcode including black and white “cells” or modules arranged in either a square or rectangular pattern. The optical representation of data 136 may be placed at a merchant's business, as discussed in detail below with respect to FIGS. 7-9.

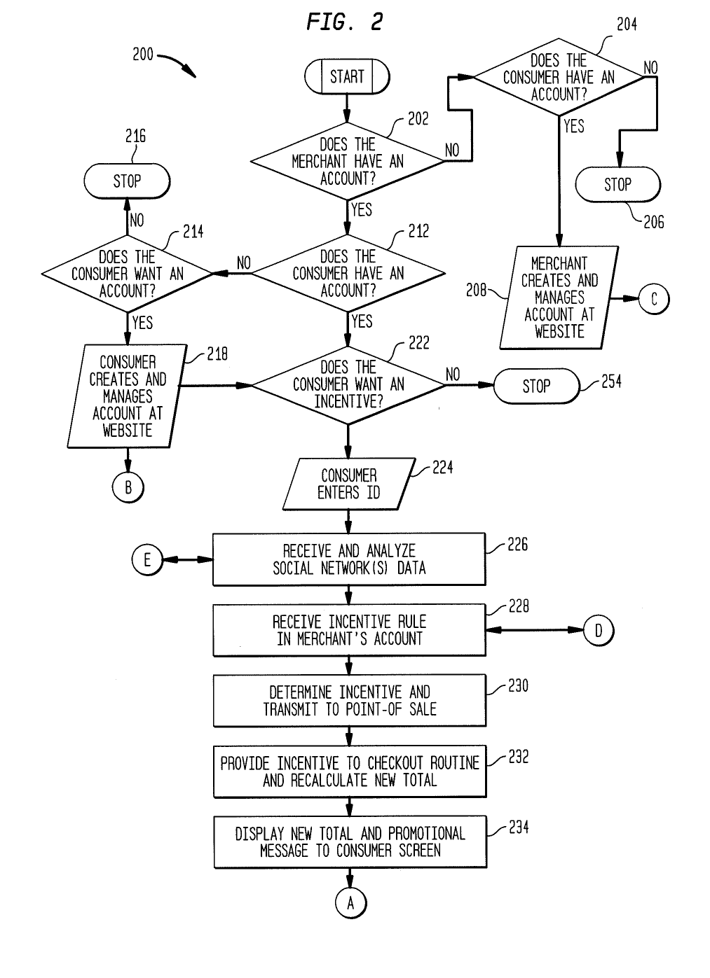

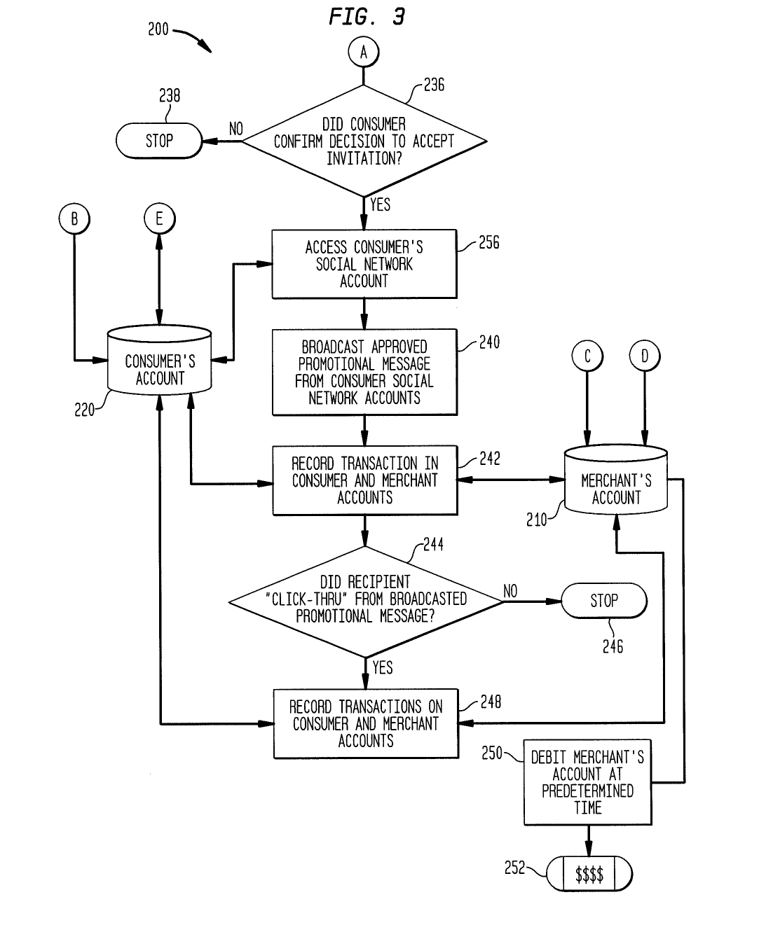

FIGS. 2 and 3 show a flowchart illustrating an example process 200 for providing an incentive to a purchasing customer with system 100. Before allowing a merchant (e.g., company, organization or individual) to generate a promotional message, the merchant first creates an account with application server 110. Accordingly, application server 110 initially determines whether the merchant has an account at block 202. If the merchant does not have an account, application server 110 asks the merchant whether it would like to create an account at decision block 204. The process ends if the merchant declines to open an account at block 206. The merchant may conversely decide to create an account and continue with the process at block 208.

At block 208, the merchant creates an account by transmitting account information to application server 110 and choosing a login username and password. Alternatively, the system may assign a username and/or password to the merchant. In any event, the merchant submits account information to application server 110. Application server 110 receives and stores the account information on a merchant account at block 210. The merchant's account is stored on application database 112. The account information may be transmitted via a website but may also be mailed or faxed. The account information may include, but is not limited to, merchant's name, mailing address, email address, merchant's website address (i.e., domain name and/or IP address), telephone number, persons permitted access to the merchant account, and a billing address and/or other billing information. The billing information may include, but is not limited to, credit card number or billing authorization information.

After creating the account, the merchant may access the account by providing the correct login username and password. Thereafter, application server 110 launches an incentive administration software. The incentive administration software allows the merchant to manage the account at block 208. To manage the account, the merchant first provides incentive information about the incentive to be offered to a purchasing customer and/or consumer. In some embodiments, the incentive administration software generates and displays one or more entry data forms, where the merchant can input incentive information. The incentive information includes, but is not limited to, rules and/or instructions to determine the value of the incentive, list of goods and/or services eligible for the incentive, a promotional message, and Uniform Resource Locator (URL) and/or link to the merchant's website. In addition, the URL may include a direct link to a purchased product or service page. In some embodiments, the administration software generates one entry data and/or user interface for inputting the incentive rules and another entry data form and/or user interface for inputting the promotional message and URLs. The promotional message may include clickable objects, such as clickable banners, clickable text and clickable links. In some embodiments, the incentive information includes a limit on the overall number of incentives that may be offered to a specific customer. The incentive itself may constitute a discount, rebate, and/or reward applied to a purchase price of an order. As discussed in detail below, the incentive may be a function of a purchasing customer's social networth score, as determined by an algorithm described with respect to FIGS. 4 and 5, and/or the total number of purchasing customer's social network contacts. The incentive information is received and stored on the merchant's account at block 210.

Once the merchant has created and setup an account, a consumer or purchasing customer can use system 100 to receive an incentive from that merchant. As used herein, the purchasing customer or consumer refers to a company, an organization and/or individual. Before the consumer can receive an incentive, application server 110 determines whether the consumer has an account at decision block 212. If the consumer does not have an account, application server 110 asks the consumer whether he or she wants to create an account at block 214. The process terminates if the consumer declines to create an account at block 216. At block 218, application server 110 allows the consumer to create an account upon an affirmative response. To create an account, the consumer submits account information via a website, fax or regular mail, and chooses a login username and password. Alternatively, the system may designate a login username and/or password to the consumer. The account information may include, but is not limited to, customer's name, mailing address, email address, and telephone number. The account information is received and stored on a consumer's account at block 220. The consumer's account is stored on application database 112.

After the account has been created, the consumer can access the account by providing the correct login username and password. Once access has been granted, the consumer is prompted to an administration software through a website, any suitable POS system, or an electronic device 134 capable of reading an optical representation of data 136. By using this administration software, the consumer can manage the account and, for example, transmit social network account data at block 218. The social network account data includes authentication information necessary to access the consumer's social network accounts and/or profile, such as social networks usernames and passwords. The social network account data is received and stored on the consumer's account at block 220. Social network account data is stored on application database 112.

The consumer may access his or her account from any suitable POS (e.g., mobile POS 128, WPOS 130 or POS device 132) or any suitable electronic device, such as a Smartphone, capable of accessing network 108. In one embodiment, the consumer can access his or her account from a WPOS embodied by a shopping cart in a merchant's website. Before or after accessing the account, the consumer is asked whether he or she wants an incentive at decision block 222. If the consumer declines the incentive, the process ends at block 254. If the consumer accepts the incentive, application server 110 executes an application software to prompt the consumer to enter his or her user identifier (e.g., username and password, digital certificate, etc.) at block 224. The steps of block 222 and 224 may be performed at a merchant's website (e.g., shopping cart and/or checkout page) and can be conducted by an embeddable software code, such as HTML or JavaScript code, plug into the merchant's transactional webpage or software or a host software application.

An embedded software code, such as an API plug-in, may be plug into the shopping cart of the merchant's website. Before or during the checkout process, the embedded software displays a message, asking the customer whether she would like an incentive, such as a discount off her purchase price. The consumer may input her response to the inquiry by, for example, selecting or clicking Yes or No on a checkbox, dropdown menu, or button displayed on the user interface. In response to a negative answer, application server 110 terminates the process. Upon an affirmative answer, application server 110 launches an authentication software, requiring the consumer's identification (e.g., username and password). Application server 110 grants access if the consumer enters the correct identification (e.g., username and password) at block 224.

When the consumer provides the correct identification, application server 110 retrieves the social network data relating to the consumer's social network account(s), at block 226, from the consumer's account at block 220. Upon receipt of the social network data, the application server 110 runs the demographic quality scoring algorithm, as described below with respect to FIG. 4, and then determines scoring information based on the consumer's social network account(s) data. This scoring information is stored on application database 112. Before providing the social network scoring information, application server 110 accesses the consumer's social network account, at block 256, to update the social network data stored on the consumer's account at block 220. The application server 110 updates the scoring information periodically. Application server 110 therefore receives updated social network data from the consumer's social network account at block 226.

After receiving the most recent social network data (i.e., scoring information based on the size and/or demographic quality of the consumer's social network contacts) along with the consumer's current geographic location, application server 110 retrieves and receives an incentive rules and promotional message, at block 228, from the merchant's account at block 210. The incentive rules may include a consumer's current geographic location, social network account metrics, such as number of social network contacts or followers, statuses count, number of messages, number of retweets, number of redemptions, content of social network messages or communications as associated with one or more predefined categories, etc. Such social network metrics are used to determine a demography quality score, as discussed in detail below. At block 230, application server 110 utilizes the incentive rules and/or instructions to determine and/or calculate the appropriate incentive to be offered the consumer based on the merchant's account settings and the scoring information for the consumer's social network account(s). Application server 110 then transmits the determined incentive to a POS or an electronic device, such as a Smartphone. In addition, application server 110 provides the determined incentive (e.g., discount, reward, or rebate) to the checkout routine of the merchant transactional software system and recalculates the total purchase price at block 232. At block 234, the new total purchase price as well as a promotional message is displayed through the consumer output device (e.g., screen) or merchant's hardware at the point-of-sale. As discussed above, the promotional message may include information about the purchase and a link to additional information about the merchant or the purchased item or service. For example, the promotional message may state: “Consumer X just got an amazing deal on this product Y at Merchant's website (hyperlink). Check it out.” In some embodiments, an incentive message is also displayed on the consumer's output device at the point-of-sale. The incentive message may include information about the incentive such as discount percentage and the total number of social network contacts. For example, the incentive message may state: “Consumer X you have Y contacts; this is worth Z % of your order.”

Subsequently, the consumer is prompted to accept or decline the incentive at block 236. The process ends if the consumer declines the incentive at block 238. If the consumer accepts the incentive, at decision block 236, application server 110 is permitted to access the consumer's social network accounts, at block 256, via network 108. The application server 110 handles the logon process in the consumer's social network account with the consumer's social network data (i.e., username and password) retrieved from consumer's account at block 220. In some embodiments, the embeddable plug-in calls a web service, such as a SOAP or RESTful web service, to finalize the transaction and broadcast the promotional message from the consumer's social network account at block 240.

Regardless of the specific method employed, applications server 110 broadcasts the promotional message, at block 240, retrieved earlier from merchant's account at block 210. The promotional message includes clickable objects, such as clickable banners, clickable text, and clickable links leading to the purchased product webpage and/or the merchant's homepage. At this point, the promotional message is broadcast through the consumer's social network(s).

The process for broadcasting the message to the consumer's social network contacts may vary. For example, the application server 110 may execute instructions to paste a software code for displaying a widget on one or more webpages within the social network. In other embodiments, application server 110 downloads a promotion application for publishing promotion banners on the social network webpage. The application server 110 then executes the downloaded promotion application to display the promotion banner. Application server 110 may nevertheless utilize any suitable viral feature to broadcast the promotional message through the consumer's social network account.

The transaction, as well as other transactional data, is then recorded in the consumer's and merchant's accounts at block 242. The merchant may then access its account, via network 108, and retrieve the recorded transactional data using the incentive administration software. The incentive administration software displays on a merchant's output device (e.g., screen) all the transactional data recorded at block 242. This transactional data may include, but is not limited to, the total number of impressions and the total number of broadcasted messages. The incentive administration software may segregate the data by time periods (e.g., all-time, monthly, weekly, daily).

Next, application server 110 determines whether any of the consumer's social network contacts click-thru the promotional message at decision block 244. If no social network contact has click-thru the promotional message, then the process ends at block 246. If any of the consumer's social network contacts has click-thru the promotional message, application server 110 tracks and records these click-thrus at block 248. The click-thru data is recorded on the consumer and merchant's accounts at blocks 220, 210. The merchant may then access the account to view the click-thru data. The incentive administration software displays the click-thru data through the merchant's output device (e.g., screen). The click-thru data may include, but is not limited to, the number of click-thrus. The click-thru data may be segregated by time periods (e.g., all-time, monthly, weekly, daily).

The E-commerce server 116 retrieves merchant's billing information from merchant's account, at block 210, and runs an E-commerce software to debit the merchant's account at block 250. The debit process may be conducted at predetermined times (e.g., nightly) or automatically after each promotional message broadcast. The debit process may entail charging a fee to the merchant's credit card. Alternatively, the E-commerce software may produce a bill and send it to the merchant via email, fax, or regular mail. After completing the debit process at block 250, E-commerce server 116 ends the promotional process at block 252. At this point, the funds collected from the merchant's account would have been transferred to the company, organization, or individual running the promotional system 100.

FIG. 4 illustrates an exemplary process or algorithm for determining the demographic qualities of one or more social network accounts, at block 226 of FIG. 2. As discussed with respect to FIGS. 2 and 3, the consumer should first create an account to receive an incentive if he or she does not already have an account. Once the consumer's account is created, the application server 110 runs an administration software that allows the consumer to input social network account data about one or more social network accounts. The social network account data includes, but is not limited to, authentication information necessary to access the consumer's social network accounts and/or profile, such as social networks usernames and passwords. This social network account data is stored on application database 112. Subsequently, the application server 110 interacts and communicates with the social network server 102 to authenticate the social network data of each social network account. Even after the consumer's account has been created, the consumer may input additional social network data about other social network accounts.

With continued reference to FIG. 4, the demographic quality score or social networth algorithm 300 includes an information extraction system or process 301. The information extraction process 301 first starts by queuing a scoring tasks or jobs. Any suitable job scheduler software, such as CRON, may be employed to queue the scoring jobs and run the jobs according to predetermined parameters. For example, the job scheduler software may be time based. A time-based job scheduler software schedules jobs to run periodically at certain times or dates. Thus, the job scheduler may run in a loop based on specific time parameters. Based on the scheduling parameters (e.g., time), the job scheduler software selects a specific consumer's account and runs the demographic quality score algorithm for such account.

Once a specific consumer account has been selected by the job scheduler software, the application server 110 retrieves social network data from the consumer's account 220. The application server 110 then uses the social network data to access each of the social network accounts associated with that specific consumer's account.

The application server 110 subsequently accesses and communicates with the social network server 102 of each social network account associated with the consumer's account at block 304. The communication between the application sever 112 and the social network server 104 may occur in a variety of ways. For example, the application server 113 may call the social network API.

Once the social network account of the consumer has been accessed, the application server 110 retrieves social network data from the consumer's social network account at block 306. This social network data may include, but is not limited to, information about the social network contacts or followers, messages, information about statuses, any other text used in communications, etc. The information about the social network contacts or followers may include, but is not limited to, the total number of contacts or followers.

The text of the social network data retrieved from each social network account is stored, standardized and aggregated in consumer's account 220 on application database 112, at block 308. The text of the social network data may be aggregated into any suitable database table, such as Character Large Object (CLOB). The social network data may be managed by any suitable database management system, such as Oracle, DB2, Microsoft Access, Microsoft SQL Server, Postgre SQL, MySQL, FileMaker, etc.

The application server 110 then filters or “cleans” the text of the social network data to exclude irrelevant information at block 310. For example, the application server 110 may “clean” the text of the social network data using Stop Words. Stop Words refers to words which are filtered out before or after processing the text of the social network data. Suitable Stop Words include, but are not limited to, “a”, “able”, “about”, “above”, “actually”, “after”, “also”, “am”, “an”, “and”, “any”, “are”, “as”, “at”, “be”, “because”, “but”, “by”, “could”, “do”, “each”, “either”, “for”, “from”, “has”, “have”, “how”, “i”, “if”, “in”, “is”, “it”, “its”, “just”, “of”, “or”, “so”, “some”, “such”, “that”, “the”, “their”, “these”, “thing”, “this”, “to”, “too”, “very”, “was”, “we”, “well”, “what”, “when”, “where”, “who”, “will”, “with”, “you”, and “your”.

As illustrated in FIG. 5, the demographic quality score process 300 further includes a textual training classification system or process 311 for associating the text retrieved from one or more social network accounts to predefined categories. The predefined categories may include automotive, business, education, entertainment, fashion, food, health, home and garden, real estate, sports, technology, travel, etc. The textual training classification process 311 implements a statistical model that, based on training data, learns associations between categories and text retrieved from one or more social network accounts. First, the textual training classification system 311 receives training data from one or more training data source, at block 312. Training data sources may include, but are not limited to, directory listings, Really Simple Syndication (RSS) feeds, categorized blogs, categorized web sites, directory listings, pre-classified business data, and advertisement traffic data. Pre-classified business data may include consumer reports information, restaurant guides, or web-based directory listings. The application server 110 may retrieve the training data sources from the Internet or any database.

Subsequently, the application server 110 trains a classifier at block 314. When training, the application server 110 builds a category model that relates the text retrieved from the social network accounts to categories. The category model may be built based on the category associations derived from the training data sources. Textual training classification process 311 may employ any suitable textual classifier known in the art, such as the naïve Bayes classifier. A naïve Bayes classifier is a probabilistic classifier based on the Bayes' theorem with strong (naive) independence assumptions. U.S. Patent Application Publication Serial No. 2010/0191768, the entire disclosure of which is herein incorporated by reference, describes in detail the operation of a naïve Bayes classifier.

$$P [ {X}_{i} \vert Y ] = \frac{P [ Y \vert {X}_{i} ] \cdot P [ {X}_{i} ]}{{\sum }_{j} P [ Y \vert {X}_{j} ] \cdot P [ {X}_{j} ]} . \qquad ( 1 )$$

In equation (1), Xᵢ represents the N possible classes (categories), wherein the integer i is in [1,N]. Y represents an event, such as text extracted from a social network account, that is to be classified into an appropriate category Xᵢ. Equation (1) gives the conditional probability of a particular category X given a extracted text Y. A particular extracted text Y may include a number of attributes (i.e., words).

During the step of training a classifier at block 314, the probabilities P[Xᵢ] on the right-hand side of equation (1) may be stored on application database 112. P[Xᵢ] represents the probability that category Xᵢ occurs and may be estimated by counting the training samples that fall into Xᵢ and dividing by the size of the training set. P [Y|Xᵢ] may be estimated using the naïve Bayes assumption. In other words, it may be assumed that the attribute values of Y are independent.

After the textual classifier has been trained, the application server 110 implements the textual classifier to compare the “cleaned” text retrieved from the social network accounts with the trained classifier. The application server 110 then renders a category report on each trained category. As discussed above, the trained categories may include automotive, business, education, entertainment, fashion, food, health, home and garden, real estate, sports, technology, travel, etc.

The application server 110 then retrieves social network metrics from the merchant's account 210 at block 318. As discussed above, social network metrics may include the number of social network contacts or followers, statuses count, number of messages, number of retweets, number of redemptions, content of messages or communications as related to one or more predefined categories. The application server 110 then determines a scaled score based on each social network metrics. For example, a consumer with a large number of communications dealing with the automotive industry would yield a high scaled score in the metric dealing with automotive information content. Also, a consumer with few social network contacts would yield a low scaled score in the metric dealing with the number of social network contacts. In another example, a consumer with a large number of messages in her social network accounts would yield a high scaled score for the metric related to the number of messages. The application server 110 determines a scaled score for each social network metric and then stores the scores on the application database 112.

As discussed above with respect to FIGS. 2 and 3, the applications server 110 utilizes the incentive rules and/or instructions in conjunction with the scaled scores to determine and/or calculate the appropriate incentive to be offered the consumer. The incentive may be based on the scores associated with one or more social network metrics. For example, a car dealership, as a merchant, may input an incentive instruction which requires calculation of the inventive based on the scaled score relating to the content of the consumer's social network communications. In this specific example, the incentive instruction may entail that a very valuable incentive will be offered to consumers who have a high scaled score on the metric dealing with automotive content in social network communications. Alternatively, the merchant might input an incentive instruction in which a very valuable incentive is offered to consumers with a high scaled score on the metric dealing with the number of social network contacts. The merchants may base their incentive rules and instructions on the scaled scores of only one metric or a combination of metrics.

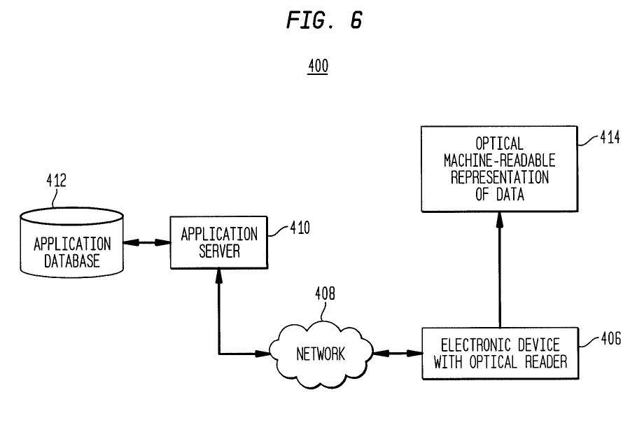

FIG. 6 schematically depicts a system 400 that allows consumers to redeem offers, deals or incentives by scanning an optical machine-readable representation of data, such as a QR code or any other suitable barcode. The system 400 may additionally include any of the components of the system 100 illustrated in FIG. 1. In this embodiment, the application server 410 includes a processor capable of running an incentive software stored on the application database 412. The application server 410 is connected to a network 408 directly or through one or more proxy servers. Network 108 may be a telephonic network, an open network, such as the Internet, a private network, such as an intranet and/or extranet, a local area network (LAN) or a wide area network (WAN) or a combination thereof. Network 408 may constitute one or more wired or wireless networks and/or collection of distinct networks operating wholly or partially in conjunction to provide connectivity to electronic device 406. Network 408 may employ any suitable protocol, such as secure sockets layer (SSL), transport layer security (TLS), or Secure HyperText Transfer Protocol (S-EPPT), to achieve a secure communication. Network 408 facilitates communication between application server 410 and electronic device 406, such as a Smartphone. Electronic device 406 includes an optical reader capable of reading optical machine-readable representations of data 414, such as QR codes or other barcodes. The optical reader may include a camera in the electronic device 406. The optical machine-readable representation of data 414 may be displayed via a physical tangible structure located at a business'physical location, at a screen or any other output device, or a marking material, such as a magazine.

The application database 412 may store incentive data containing information about deals, offers or any other incentive to a purchasing consumer. Merchants may input such incentive data via a user interface, as described above with respect to the embodiments illustrated in FIGS. 1-5. In some embodiments, the merchants may have accounts as described above with respect to the embodiments depicted in FIGS. 1-5. Consumers may also have accounts, as described above with respect to the embodiments illustrated in FIGS. 1-5. Consumers' accounts may have information about the consumer's social network accounts.

The application server 410 may retrieve incentive data from the application database 410 and transmit the data to the consumer via network 408. The consumer may communicate with the application server 410 via network 408 to access the incentive data stored on application database 412. In specific example, the consumer may communicate with the application server 410 via a website. Alternatively, the consumer may download an application into her electronic device 406 to facilitate communication between the application server 410 and the electronic device 406. Using the downloaded application, the consumer may read the incentives, deals or offers available through a display output (e.g., screen) of the electronic device 406.

FIG. 7 illustrates a flowchart of an exemplary method of using system 400. First, a merchant creates one or more incentives and stores information about such incentives on application database 412 (i.e., incentive data). The application server 410 may have a processor capable of running an incentive software. The incentive software may include a user interface that allows merchants to input incentive data, as seen at block 416. The incentive data is then stored on application database 412 and may include any information necessary to determine the incentive to be offered to a purchasing customer, including, but not limited to, discount percentages, valid dates and times, etc.

At block 418, the incentive application running on the application server 410 then creates a barcode, such as a QR bode, or any other suitable optical machine-readable representation of data, which is associated with the specific incentive inputted by the merchant. The barcode is stored on the application database 412. The barcode is then displayed on any suitable location at block 420. For instance, a physical printout of the barcode may be placed at the place of business of the merchant offering the discount. Alternatively, the barcode may be displayed on a screen at the place of business of the merchant offering the discount. The barcode may also be displayed on any marketing media, such as television ads, magazines, billboards, etc.

Once the barcode is displayed at a suitable location, the consumer may use the optical reader of its electronic device 406 to read the barcode at block 422. The electronic device 406 then communicates with application server 410 and retrieves information about the incentive associated with barcode read by the optical reader. The incentive application running on the application server 410 then prompts the user to answer whether she would like to accept the inventive at decision block 426. If the consumer declines the incentive, the application server 410 terminates the incentive software at block 428. If the consumer accepts the incentive, the incentive software broadcast a promotional message from the consumer's social network accounts at block 430. Subsequently, information about the incentive is displayed on the consumer's electronic device at block 432. At this point, the consumer may redeem its incentive by providing the merchant with the information about the incentive. For example, the purchasing consumer may simply show the merchant the information about the incentive displayed on her electronic device, as seen at block 432.

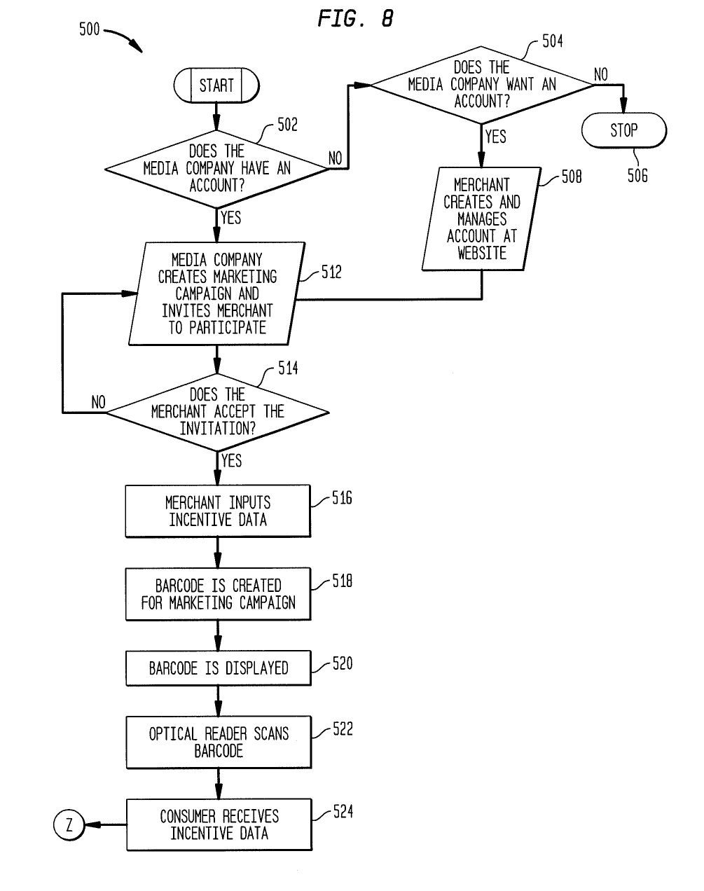

The system 400 depicted in FIG. 6 may be used to perform the process 500 illustrated in FIG. 8. As discussed above, the system 400 may additionally include any of the components depicted in FIG. 1. In certain embodiments, the system 400 allows media companies to display a barcode, such as QR codes or any other suitable optical machine-readable representation of data in a traditional broadcast, publication or out-of-home media placement. For example, the barcodes may be displayed in a snipe (e.g., at a lower third of a screen) during regular television broadcasts.

The application server 410 runs a marketing and advertising software or platform, enabling media companies to create marketing campaigns for consumers who have downloaded a Smartphone application. Media companies may input and store marketing campaign data on application database 412 via application server 410. The marketing campaign data may include a marketing communication, an original deal and a social media deal. The original deal will be offered to the consumers who have downloaded the Smartphone application, whereas the social media deal will be offered to social network contacts or friends of that consumer. In addition to the original deal and the social media deal, the marketing campaign data may include a title, a marketing communication, a name of the merchant offering the original and social media deals, the start date of the deals, the expiration date of the deals, and information about the placement or location of the barcodes. The information about the placement of the barcodes may include the physical location where the barcodes will be placed.

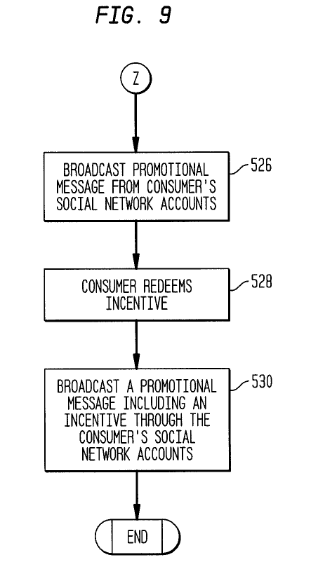

As seen in FIGS. 8 and 9, process 500 begins when marketing and advertising software executed by the application server initially determines whether the media company has an account at block 502. If the media company does not have an account, application server 410 asks the media company whether it would like to create an account at decision block 504. The process ends if the media company declines to open an account at block 506. The media company may conversely decide to create an account and continue with the process at block 508.

At block 508, the media company creates an account by transmitting account information to application server 410 and choosing a login username and password. Alternatively, the system may assign a username and/or password to the media company. Application server 410 receives and stores the account information on application database 412. The account information may be transmitted via a website but may also be mailed or faxed. The account information may include, but is not limited to, media company's name, mailing address, email address, media company's website address (i.e., domain name and/or IP address), telephone number, persons permitted access to the merchant account, and a billing address and/or other billing information. The billing information may include, but is not limited to, credit card number or billing authorization information.

After creating an account, the media company may input marketing campaign data to create one or more marketing campaigns at block 512. As discussed above, marketing campaign data may include a title, a marketing communication, an original deal, a social media deal, the start date of the deals, the expiration date of the deals and the placement specifics of the barcode.

In creating the marketing campaigns, the media company may invite a merchant with an existing account, as described in detail above with respect to the embodiment illustrated in FIGS. 1-5, to participate in the marketing campaign. The media company may click an invite button on the marketing and advertising platform to invite a merchant to participate in the marketing campaign. At this point, the media company and the merchant receive one or more electronic communications (e.g., emails) confirming the invitation.

The electronic communication may include a deep-link. When the merchant clicks this deep-link, a webpage opens in a web browser. Such webpage contains a pre-populated form with the information previously entered by the media company. At this website, the merchant may decide whether or not to participate in the marketing campaign. Thus, the advertising and marketing software asks the merchant whether it would like to participate in the marketing campaign of the media company at block 514. If the merchant declines to participate in the marketing campaign, the media company may invite another merchant. If the merchant accepts to participate in the marketing campaign, the merchant may input incentive data at block 516. This incentive data may include, among other things, original deal data, social media deal data, and start and expiration dates of such deals. At this time, the media company and the merchant both receive electronic communications (e.g., emails) confirming the acceptance of the invitation.

The marketing and advertising software then creates a barcode, such as a QR code or any other suitable optical machine-readable representation of data, for the specific marketing campaign at block 518. Such barcode is available to the media company. The media company may access the barcode when clicking a link in the electronic communication sent to them confirming acceptance of the marketing campaign by the merchant. The barcode may also be available when the media company accesses its account and view the details of the marketing campaign.

At block 520, the barcode is then displayed in any suitable marketing communication. For instance, the barcode may be displayed in traditional broadcast, publications, out-of-home forms of advertisements or any other suitable marketing communications.

A consumer may scan the barcode with an optical reader of the electronic device 406 to retrieve incentive data (e.g., the original deal from the merchant participating in the marketing campaign) at block 522. For example, the customer may read the barcode using a Smartphone and the downloaded application. To retrieve the incentive data associated with the scanned the barcode, the customer may simply click an “unlock” button displayed by the downloaded application in the Smartphone. Upon clicking the “unlock” button, the application server 410 receives input from a customer indicative that the barcode has been read by an optical reader. When the application server 410 receives such input, it transmits the incentive data associated with the scanned barcode to the consumer's electronic device 406, at block 524. Thus, the consumer receives the incentive data. Additionally, the application server 410 automatically broadcasts one or more promotional messages from the consumer's social network account(s) at block 526. For example, the promotional message may be posted as a status message in the consumer's social network accounts. At this point, the incentive is unlocked and ready to be redeemed.

When the consumer receives the incentive data from the application server 410, she can view and store the incentive data (e.g., original deal) on her electronic device 406. The incentive may be redeemed by scanning a barcode 414, such as a QR code, at the merchant's point-of-sale using electronic device 406 at block 528. When the consumer redeems the incentive (e.g., original deal), the application server 410 receives input indicative that the consumer's has scanned a barcode 414 to redeem an incentive. At this point, a promotional message, which may include the social media deal, is broadcast via the consumer's social network accounts at block 530. For example, a promotional message including a social media deal may be posted on the consumer's social network accounts as a status message or the like.

The media company may pay fees for each impression, based on the reach of the consumer's social networks. To collect the fees, the system 400 may perform the E-commerce process described with respect to FIG. 3. The fees may be collected at specific times. For example, the system 400 may bill the media companies on a 30-day cycle. The fees may range from $0.10 to $10 per impression based on category assigned to the media company.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with other of the described embodiments.

1. A method for providing incentives to a customer associated with a social network site, comprising:
receiving identification data from a customer;
receiving incentive data from a merchant, the incentive data including at least one predefined category;
accessing at least one social network account of the customer to access social network data associated with the customer, the social network data including text of social network communications and a size of the at least one social network account as measured by a number of social network contacts of the customer;
determining demographic qualities of the at least one social network account including comparing the text of the social network communications with the at least one predefined category;
determining an incentive based on the size and demographic qualities of the at least one social network account and the incentive data with a processor;
receiving input from the customer as to whether to accept the incentive determined by the processor; and
broadcasting a promotional message through the at least one social network account of the customer if the costumer accepts the incentive.

2. The method according to claim 1, wherein the receiving incentive data step further comprises receiving computer-readable instructions including a discount on a purchase price based on the size and demographic qualities of the at least one social network account.

3. The method according to claim 1, wherein the step of receiving identification data from the customer includes receiving a username and password from the customer.

4. The method according to claim 1, wherein the step of determining the incentive includes determining a discount to be applied to a purchase price of an order to be completed by the customer.

5. The method according to claim 4, further comprising the step of transmitting an incentive message to the customer, the incentive message including information about the determined discount.

6. The method according to claim 1, further comprising storing the social network data of the customer in a non-transitory computer-readable medium.

7. The method according to claim 1, further comprising the step of storing the incentive data in a non-transitory computer-readable medium.

8. The method according to claim 7, wherein the step of determining the incentive comprises retrieving incentive data from the computer-readable medium.

9. The method according to claim 1, further comprising the step of storing transactional data about the purchase in a non-transitory computer-readable medium.

10. The method according to claim 1, wherein the step of broadcasting a promotional message through the at least one social network account of the customer further comprises providing a link to additional information regarding the purchase of the customer.

11. The method according to claim 10, further comprising detecting clicking of the link.

12. The method according to claim 11, wherein the step of detecting clicking of the link comprises generating clicking data, the clicking data including a number of clicks to the link.

13. The method according to claim 12, further comprising the step of storing the clicking data in a computer-readable mediums.

14. The method according to claim 13, further comprising conveying the clicking data to a merchant through an output device.

15. The method according to claim 1, wherein the step of broadcasting a promotional message through the social networks of the customer includes accessing at least one social network account of the customer.

16. A system for providing incentives to a customer associated with a social network site, comprising:
a social network database for storing social network data associated with users of a social networking site;
a social network server coupled to the social network database;
an application server capable of establishing communication with the social network server via a network and receiving social network data stored on the social network database, wherein the application server is configured to:
receive identification data from a customer;
receive incentive data from a merchant;
communicate with the social network server to retrieve social network data about the customer, the social network data including text of social network communications and a size of a social network account of the customer as measured by a number of social network contacts;
determine demographic qualities of the social network account by comparing text of the social network communications with predefined categories;
determine an incentive based on the incentive data provided by the merchant and the size and demographic qualities of the social network account of the customer;
receiving input from the customer as to whether to accept the incentive determined by the processor; and
broadcast through the social network of the purchasing customer a promotional message if the customer accepts the incentive; and
an application database coupled to the application server for storing social network data about the customer.

17. The system according to claim 16, further comprising a merchant server including a merchant transactional system configured to process transactions from the customer, wherein the application server is capable of interacting with the merchant transactional system via the network.

18. The system according to claim 17, further comprising a point-of-sale device coupled to the merchant transactional system.

19. The system according to claim 18, wherein the point-of-sale device is selected from a group consisting of a web-based point-of-sale module, a point-of-sale terminal, a mobile device, and a combination thereof.

20. A non-transitory computer readable medium including instructions that, when executed by a processor, causes the process to perform the following steps:
receiving identification data from a customer;
receiving incentive data from a merchant, the incentive data including at least one predefined category;
accessing at least one social network account of the customer to retrieve social network data associated with the customer, the social network data including text of social network communications and a size of the at least one social network account as measured by a number of social network contacts of the customer; determining demographic qualities of the social network data including comparing the text of the social network communications with the at least one predefined category;
determining an incentive based on the incentive data, the demographic qualities of the social network data, and the number of social network contacts of the consumer;
receiving input from the customer as to whether to accept the incentive determined by the processor; and
if the customer accepts the incentive, broadcast a promotional message through the at least one social network account of the customer.

21. A method for providing incentives to a customer associated with a social network site, comprising:
receiving incentive data from a merchant, the incentive data including computer-readable instructions about a purchasing incentive;
creating a barcode associated with the incentive data from the merchant;
displaying the barcode;
receiving input from a customer indicative that the barcode has been read by an optical reader;
associating the barcode read by the customer with the incentive data provided by the merchant with a processor;
receiving input from the customer as to whether to accept the incentive determined by the processor; and
broadcasting a promotional message through at least one social network account of the customer if the costumer accepts the incentive.

22. The method according to claim 21, wherein the step of creating a barcode includes creating a QR code.

23. A method for providing incentives to a customer associated with a social network site, comprising:
receiving marketing campaign data from a media company, the marketing campaign data including information about a marketing campaign;
receiving incentive data from a merchant, the incentive data, the incentive data being associated with the marketing campaign data and including information about a first incentive;
creating a barcode associated with the marketing campaign data from the media company;
displaying the barcode;
receiving input from a customer indicative that the barcode has been read by an optical reader;
associating the barcode read by the customer with the marketing campaign data provided by the media company and the incentive data with a processor;
receiving input from the customer as to whether to accept the first incentive; and
broadcasting a first promotional message through at least one social network account of the customer if the costumer accepts the first incentive;
receiving input from the customer indicative that the customer redeemed the first incentive; and
broadcasting a second promotional message through the at least one social network account of the customer when costumer redeems the first incentive, the second promotional message including a data about a second incentive.
